(19) United States
(12) Patent Application Publication
(10) Pub. No.: US 2003/0157315 A1
(43) Pub. Date: Aug. 21, 2003

(54) Insulating flame-resistant fabrics

(76) Inventor: James R. Green, Bonita Springs, FL (US)

Correspondence Address: Terry M. Gernstein, 1015 Salt Meadow Lane, McLean, VA, 22101, US

(21) Appl. No.: 10/285,434

(22) Filed: Nov. 1, 2002

Related U.S. Application Data
(63) Continuation-in-part of application No. 10/078,170, filed on Feb. 20, 2002.

(51) Int. Cl. B32B 3/02

(52) U.S. Cl. 428/317.9; 442/208; 428/311.11; 428/311.71; 428/82

(57) ABSTRACT

Insulating flame-resistant woven fabrics have been discovered which have a nap on the back side of the fabric to provide extra comfort and heat resistance without reduction in wear life or increased pilling.

### RELATED APPLICATIONS

The present application is a continuation-in-part application of application Ser. No. 10/078,170 filed on Feb. 20, 2002 by the inventor herein named. The disclosure of the just-mentioned 10/078,170 application is incorporated herein by reference.

### DESCRIPTION

This invention adds enhanced thermal protection to light weight long wear life flame-resistant woven fabrics by sanding the backside of 3×1 or 4×1 twill or sateen flame-retardant treated cotton and flame-retardant treated cotton blend fabrics by controlling the strength loss due to sanding such that the tears along the warp direction which break the fill yarns require at least 3 lbs and no more than 7 lbs to propagate.

### BACKGROUND

It is well known in the prior art that woven fabrics can be finished by abrading one or both surfaces to obtain a soft surface texture resembling a suede leather or prewashed fabric as is explained in U.S. Pat. Nos. 4,918,795, 4,863,775, 4,837,902 and the teachings are entirely incorporated herein by reference. The sueded or washed feeling in the fabric is created by raising the fibers of the constituent material while at the same time nicking or splitting some of the raised ends to soften the filaments. Efficient ways of flame-retarding fabrics made from blends of cotton and thermoplastic fibers with tetrakis (hydroxymethyl) phosphonium compounds (THP) are described in U.S. Pat. Nos. 4,909,805 and 5,480,458. The use of thermoplastic fiber reinforcement to increase the wear life of fabrics is described in U.S. Pat. Nos. 2,423,827, 4,920,000, 4,941,884, 4,578,306 5,468,545. Normal wear life of 100% optimally flame-retardant treated cotton is about 65 servicings and over 100 for those reinforced with thermoplastic fibers. Napping can substantially reduce wear life of 100% flame-resistant cotton fabrics as well as those reinforced with thermoplastic fibers so napping is limited to heavy weight woven fabrics. Also when thermoplastic fibers are incorporated into fabrics to increase wear life, these strong fibers hold the cotton balls on the sanded surface producing an unsightly appearance and reducing the effectiveness of the insulating layer. A number of methods for reducing pilling are well known which involve weakening the thermoplastic fibers with or without temporarily immobilizing them as explained in U.S. Pat. No. 5,468,545 and the teachings are incorporated entirely herein by reference. Knit fabrics have long been used to make pile fabrics because some knit structures lend themselves to forming loops, which can be cut without loosing fabric integrity. Knits are not the subject of this patent.

### SUMMARY OF THE INVENTION

This invention provides light weight cotton and cotton/thermoplastic fiber blend flame-resistant woven fabrics with an insulating pile on the fill face side with no reduction in wear life compared with the unnapped fabric and no increase in pilling. It has been discovered that woven 3×1 and 4×1 twill and sateen fabrics of no more than 10 oz/yd2 basis weight that contain warp yarns comprising 0-30% nylon, 70-100% flame-retardant treated cotton in the warp and 100% flame-retardant treated cotton in the fill can be sanded on the fill face side without inducing pilling and without a significant reduction in wear life provided that the final sanded fabrics have a tear strength of no less than 3 lbs and no more than 7 lbs when fabrics are torn across along the warp direction to break the fill yarns.

### DETAILED DESCRIPTION OF THE INVENTION

The staple fibers used herein are textile fibers having a linear density suitable for wearing apparel, i.e., less than 10 decitex per fiber, preferably less than 5 decitex per fiber. Still more preferred are fibers having a linear density of 1 to 3 decitex per fiber and length from 1.9 to 6.3 cm (0.75 to 2.5 in). Crimped fibers are particularly good for textile aesthetics and processibility.

If reinforcement is to be done it is important to use nylon in the warp because it has the best fatigue life of all of the commercially available thermoplastic fibers and is capable of maintaining the integrity of the warp much better than other fibers, such as polyester, when the garment is abraded by normal wash and wear conditions. The warp yarn pinches the fill yarns at crossover points and slows down the rate at which the broken ends in the sanded fill yarns come free and the fabric breaks. With less than 15% nylon in the yarns, normal wash and wear fatigue will quickly loosen the grip of the warp yarns and subsequently the fill yarns weakened by sanding will break prematurely and the warp yarns will follow so that holes are formed. With more than 30% nylon in the warp, the fabrics lose a significant part of their flame-resistance. The fill must be 100% flame-retardant treated cotton because sanding thermoplastic blends like nylon blend yarns can cause pilling and the fabric will bum once the nylon fibers are raised and have increased access to oxygen.

Fill yarns must cross over at least 3 or 4 warp yarns in order to shield the warp yarns from the sander when the fabric is rubbed on the backside. Twills and sateen of 3×1 or 4×1 construction are suitable for this purpose whereas plain weave or fabrics of 2×1 construction are not. Fabrics of a style which allows too much exposure of the warp yarns on the backside will lose warp tensile and tear strength upon sanding and styles wherein the yarn crossover points of warp and fill are too far apart will weaken and have poor wear life after sanding as the broken fibers will fall out.

While sanding will not cause fabrics of the invention to pill during washing or wearing or cause significant warp damage, it will cause strength loss in the fill direction. In order to maintain wear life the fill strength must not be reduced below 3 lbs during the sanding operation. In order to obtain a sufficient level of nap to provide thermal insulation fill strength should be reduced to less than 7 lbs. Sanding can occur at any stage in the production of the fabric, greige, after flame-retarding treatment or after the fabric has been compressively shrunk, such as by sanforization.

Fabrics must be flame-retardant treated in order to meet the objective of the invention which is to provide fabrics with flame-resistance and enhanced thermal insulation. At least two satisfactory commercial products are available. One is Pyroset® TPO, a THPS/urea precondensate of tetrakis (hydroxymethyl) phosphonium sulfate and Urea available from Freedom Chemical Company, Charlotte, N.C. The other is THPC/urea prepolymer condensate of tetrakis (hydroxymethyl) phosphonium chloride and urea sold by Albright and Wilson. While these compounds are ammonia cured, other phosphorus flame-retardant chemicals may also be used which involve heat treatment for curing.

### Measurements

Tear strength of fabrics was measured using the American Society for Testing Materials (ASTM) test D 1424, Elmendorf tear. Tensile strength was measured using ASTMD-D5035-95, strip tensile. Fabric pieces were folded and sewn together at cut edges with the fill face on the inside of the fabric to simulate a sewn garment. Sewn 100% flame-retardant treated cotton fabric pieces were washed and dried 65 times and sewn fabrics containing synthetic fiber reinforcement with flame-retardant treated cotton were laundered and dried 100 times. Both were examined for pilling on the inside. Pilling was determined by empirical analysis and rated as non-pilling, moderate, substantial. Holes or significant fiber loss from abrasion were used to determine wear life.

### EXAMPLE 1

Woven fabric was made as a 3×1 twill having in the warp 25% of polyhexamethylene adipamide (6,6 nylon) fibers and 75% cotton. The fill was 100% cotton. The fabric was prepared, dyed and flame-retardant treated such that it contained 2.5% phosphorus. The fabric was compressively shrunk to loosen the structure. It was then sanded on the fill face side using a conventional multi-roll sander with fine grit sandpaper. A noticeable pile was generated on the fill face side of the fabric. Fill tear strength was reduced to 5 lbs. Sewn fabric pieces washed and dried 100 times showed no signs of pilling and wear, like that of unsanded fabric of the same construction.

### EXAMPLE 2

The same woven fabric described in Example 1 was sanded after flame-retardant treatment to create an insulative pile. Fill strength was reduced from to 4 lbs. The fabric was compressively shrunk to reduce shrinkage. Fabrics washed and dried 100 times showed no signs of pilling or wear. Comparative Example A not of this invention was made by sanding such that fill strength was reduced to 2 lbs. Sewn fabric pieces washed and dried 100 times had holes.

### EXAMPLE 3

Woven fabric was made as a 4×1 sateen having in the warp and fill 100% cotton. The fabric was prepared, dyed and flame-retardant treated such that it contained more than 2% phosphorus. It was compressively shrunk. It was then sanded on the fill face side using a conventional multi-roll sander with fine grit sandpaper. Fill tear strength was reduced to 4 lbs. Sewn pieces washed and dried 65 times showed no signs of pilling and had minimal wear similar to unsanded fabric of the same construction.

We claim:

1. Insulating durable flame-resistant fabrics of 3×1 and 4×1 twill or sateen construction with a basis weight of no more than 10 oz/yd2 with a nap on the fill face side in which warp yarns contain 0 to 30% nylon fibers and 70 to 100% flame-retardant treated cotton fibers and the fill yarns are 100% flame-retardant treated cotton; said fabrics containing at least 1% phosphorus by weight of fabric and having a fill yarn tear strength of no less than 3 lbs and no more than 7 lbs.

2. The fabrics of claim 1 having a fill tear strength of no more than 5 lbs.

3. The fabrics of claim 1 in which the nylon fibers are T-420 fibers from Dupont.

4. The fabrics of claim 1 which contains at least 2% of phosphorus by weight of fabric as part of an ammonia cured flame-retardant.

5. The fabrics of claim 1 which contains at least 1% of phosphorus by weight of fabric as part of a heat cured flame-retardant.
